(19) United States
(12) Patent Application Publication
(10) Pub. No.: US 2011/0302247 A1
(43) Pub. Date: Dec. 8, 2011

(54) CONTEXTUAL INFORMATION DEPENDENT MODALITY SELECTION

(75) Inventors: Giridhar Kalpathy Narayanan, Bellevue, WA (US); Rajesh Ramanathan, Redmond, WA (US); Srivatsa K. Srinivasan, Renton, WA (US); Lokesh Srinivas Koppolu, Redmond, WA (US)

(73) Assignee: MICROSOFT CORPORATION, Redmond, WA (US)

(21) Appl. No.: 12/792,033

(22) Filed: Jun. 2, 2010

(51) Int. Cl. G06F 15/16

(52) U.S. Cl. 709/205

(57) ABSTRACT

Modality selection in establishing multimodal conversations is performed automatically based on contextual information in enhanced communication platforms. Automata in client machines determine how a client machine chooses one or more modalities of a conversation invite based on contextual information such as computing device environment, network environment, user presence state, and comparable factors. Executed automata automatically join the user to a selected modality of a conversation or reject one.

### BACKGROUND

In current communication applications, a call may consist of multiple modalities such as Instant Messaging (IM), white-boarding, application or desktop sharing, audio and video peer-to-peer and multiparty conferences, and comparable ones. These modalities may occupy limited resources on the user's machine such as screen real estate, processing capacity, memory, and similar resources. Each additional modality may lead to less available resources, which may negatively impact a user's other tasks on the same machine.

In some cases, a user may want to join only certain modalities of an ongoing or newly beginning conversation. The user's choice may depend on the user's state and the state of the user's client machine. The user may be incapable of communicating in certain modalities. The user may not want to join all the modalities and occupy significant resources on his/her machine.

In other cases, the user may not comprehend their communication environment and, as such, may be susceptible to a poor experience (or quality) in one or more of the modalities. If the user is provided with the option of selecting individual modalities each time they are to join a conversation, they may be given control over how they want to converse, but the experience may be a tedious one degrading the user experience. Moreover, the user may still be unable to determine the conditions of the processing and/or communication environment (e.g. bandwidth limitations, processing capacity or memory limitations, etc.). As a result, acceptance of some modalities may negatively affect the quality of the conversation.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to managing contextual information dependent modality selection in enhanced communication platforms. Automata in client machines may determine how a client machine chooses one or more modalities of a conversation invite. Executed automata may automatically join the user to a selected modality of a conversation.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 is a diagram illustrating an example enhanced communications system, where embodiments may be implemented for managing contextual information dependent modality selection;

FIG. 2 is a conceptual diagram illustrating basic components of an example system for management of contextual information dependent modality selection across different systems;

FIG. 3 is a block diagram illustrating major components of a system according to embodiments for managing contextual information dependent modality selection;

FIG. 4A illustrates an example user interface displaying contextual information dependent modality selection according to some embodiments;

FIG. 4B illustrates the example user interface of FIG. 4A displaying contextual information dependent modality selection under different circumstances;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of managing contextual information dependent modality selection in an enhanced communication system according to embodiments.

### DETAILED DESCRIPTION

As briefly described above, contextual information dependent modality selection may be managed by determining user state and executing matching automata rules. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “server” generally refers to a computing device executing one or more software programs typically in a networked environment. However, a server may also be implemented as a virtual server (software programs) executed on one or more computing devices viewed as a server on the network. Similarly, a “client” may refer to a computing device enabling access to a communication system or an application executed on a computing device enabling a user to access a networked system such as a social networking service, an email exchange service, and comparable ones. More detail on these technologies and example operations is provided below. A “call” as used herein refers to a single or multimodal conversation with the example modalities provided throughout the disclosure. Thus, a “call” is not limited to traditional audio only communications.

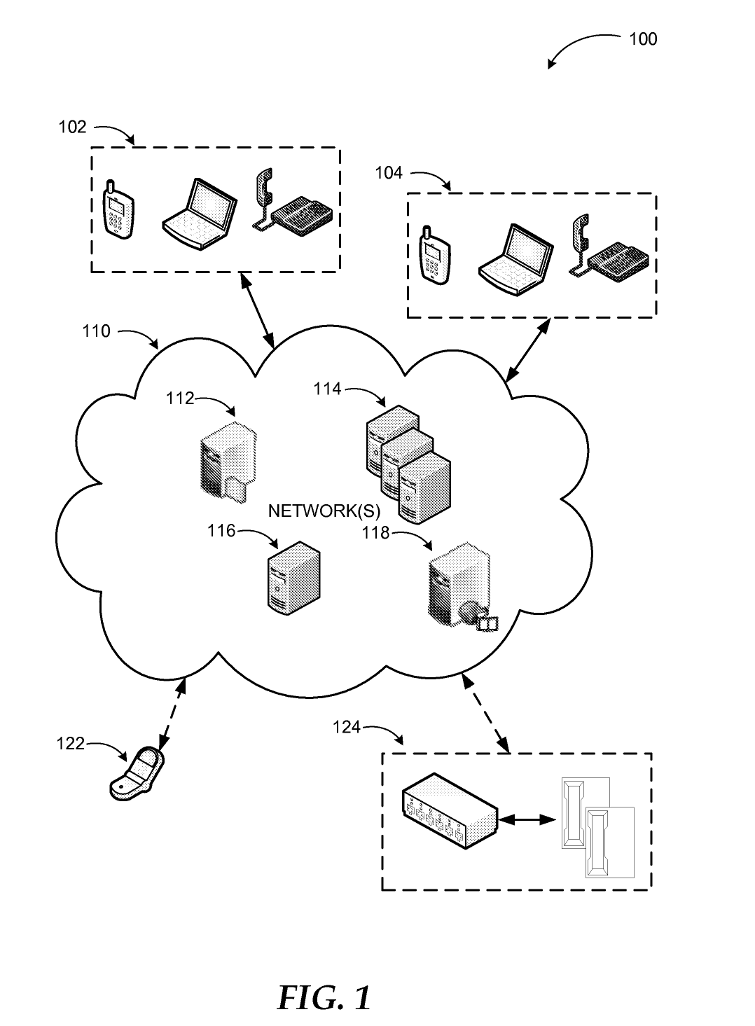

Referring to FIG. 1, diagram 100 of an example enhanced communication system, where embodiments may be implemented for managing contextual information dependent modality selection, is illustrated Enhanced communication systems such as a unified communication system provide subscribers the ability to facilitate multi-modal communications. While such systems may integrate various aspects of multi-modal communications such as automated modality selection, subscribers may also participate in other systems such as social networking systems, other email systems, and similar ones. Thus, an enhanced communication system may provide a suitable platform for managing contextual information dependent modality selection across various platforms. A unified communication system is an example of modern communication systems with a wide range of capabilities and services that can be provided to subscribers. A unified communication system is a real-time communications system facilitating instant messaging, audio-video conferencing, web conferencing functionality, and comparable capabilities.

In a unified communication (“UC”) system such as the one shown in diagram 100, users may communicate via a variety of end devices (102, 104), which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through PBX 124 to a Public Switched Telephone Network (“PSTN”). End devices may include any type of smart phone, cellular phone, any computing device executing a communication application, a smart automobile console, and advanced phone devices with additional functionality. Moreover, a subscriber of the UC system may use more than one end device and/or communication application for facilitating various modes of communication with other subscribers. End devices may also include various peripherals coupled to the end devices through wired or wireless means (e.g. USB connection, Bluetooth connection, etc.) to facilitate different aspects of the communication.

UC Network(s) 110 includes a number of servers performing different tasks. For example, UC servers 114 may provide registration, presence, and routing functionalities. Routing functionality enables the system to route calls intended for a user to anyone of the client devices assigned to the user based on default and/or user set policies. For example, if the user is not available through a regular phone, the call may be forwarded to the user's cellular phone, and if that is not answering a number of voicemail options or forwarding of the incoming call to one or more designated people may be utilized. Since the end devices may be capable of handling additional communication modes, UC servers 114 may provide access to these additional communication modes (e.g. instant messaging, video communication, etc.) through access server 112. Access server 112 resides in a perimeter network and enables connectivity through UC network(s) 110 with other users in one of the additional communication modes. UC servers 114 may include servers that perform combinations of the above described functionalities or specialized servers that only provide a particular functionality. For example, presence servers providing presence functionality, home servers providing routing functionality, rights management servers, and so on. Similarly, access server 112 may provide multiple functionalities such as firewall protection and connectivity, or only specific functionalities.

Audio/Video (A/V) conferencing server 118 provides audio and/or video conferencing capabilities by facilitating those over an internal or external network. Mediation server 116 mediates signaling and media to and from other types of networks such as a PSTN or a cellular network (e.g. calls through PBX 124 or from cellular phone 122). Mediation server 116 may also act as a Session Initiation Protocol (SIP) user agent.

In a UC system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a commonly used method.

SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

SIP clients may use Transport Control Protocol (“TCP”) or Transport Layer Security (“TLS”) to connect to SIP servers and other SIP endpoints. SIP is primarily used in setting up and tearing down voice or video calls. However, it can be used in any application where session initiation is a requirement. These include event subscription and notification, terminal mobility, and so on. Voice and/or video communications are typically done over separate session protocols, typically Real-time Transport Protocol (“RTP”).

Contextual information dependent modality selection may be managed by one or more clients of the UC system by monitoring a user state. The user state may be determined from a number of variables such usage of applications on a client device, feedback from a scheduling application, client machine resource availability, network resource availability, and the like. The client may store one or more automata rules for a user. After receiving an invite to join a conversation, the client may select an automata rule based on the user's determined state and automatically activate a modality according to the selected rule and in a selected fashion, one-way or two-way.

While the example system in FIG. 1 has been described with specific components such as mediation server, A/V server, and similar devices, embodiments are not limited to this system of the example components and configurations. An enhanced communication system facilitating contextual information dependent modality selection management may be implemented in other systems and configurations employing fewer or additional components. Furthermore, such systems do not have to be enhanced communication systems integrating various communication modes. Embodiments may also be implemented in systems facilitating different communication modes distinctly by coordinating implementation of the rules across different communication modes using the principles described herein.

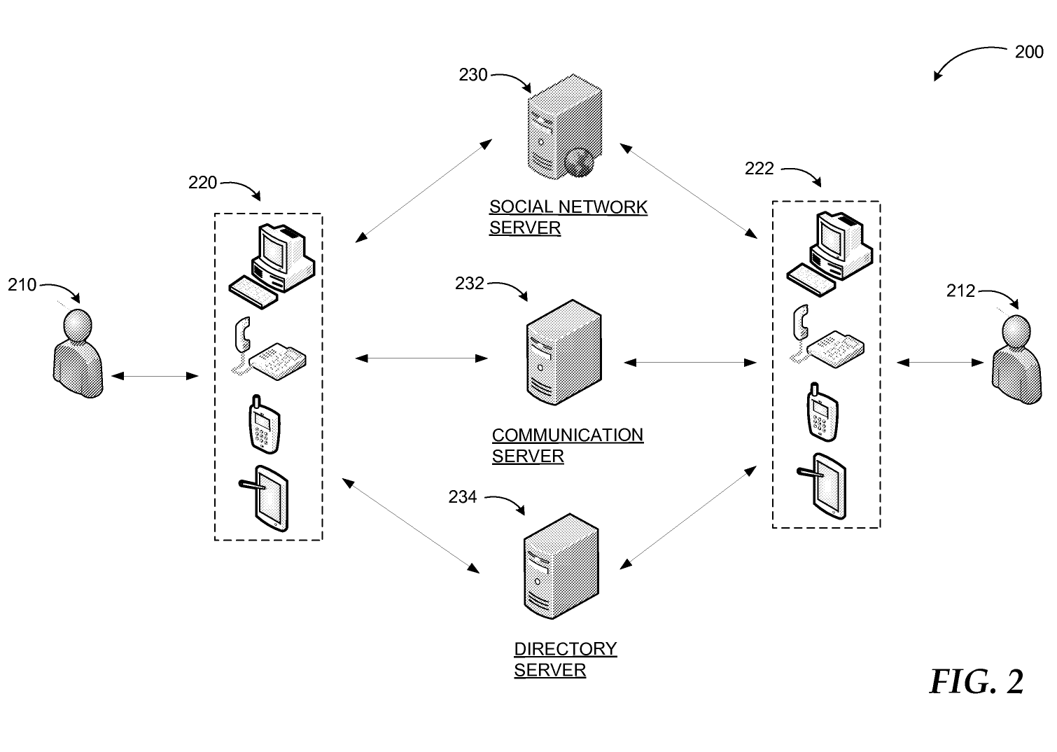

FIG. 2 includes conceptual diagram 200 illustrating a basic example system managing contextual information dependent modality selection across different systems. While a system according to embodiments is likely to include a number of servers and services such as those illustratively discussed in FIG. 1, only those relevant to embodiments are shown in FIG. 2.

A subscriber 210 may send a call invite to the subscriber 212 by the use a variety of client (end-point) devices 220, including a desktop computer, a landline phone, a cellular phone, a smart phone, and others. The call invite may include multiple call modalities. The subscriber 212 may receive the call invite through the variety of client devices 222.

Contextual information dependent modality selection for a subscriber 212 may be computed, among other things, based on presence information from the client devices 222. A communication server 232 may monitor the presence state of the subscriber by retrieving the presence information from the variety of client devices. Some aspects of determining the user's state for modality selection may include whether the user is already in a conversation, if the existing conversation is an important conversation, and if the existing conversation is with a specific group of people. Information for determining those aspects may be received from a directory server 234 and/or a social network server 230. It should be noted that conversations may be single or multimodal. Thus, the user may be in the middle of an instant message session with their supervisor and may not wish to accept a video conference invite from one of their peers or a subordinate. By detecting the existing instant message session and the parties involved in that session, the client application may provide the user an alert that a video conference invite has been received and will be declined giving the user an option to still accept the invite if she/he wishes to do so. Similarly, if the user is on a phone or a mobile device, his/her communication may be primarily audio/instant message driven.

The contextual information dependent modality selection may be processed as described above. In addition, the client devices may retrieve subscriber defined presence information from the directory and social networking servers. The end devices may compare the subscriber contextual information and match the contextual information to an automata rule. The client may then execute the matching automata rule to initiate the selected call modality of the rule.

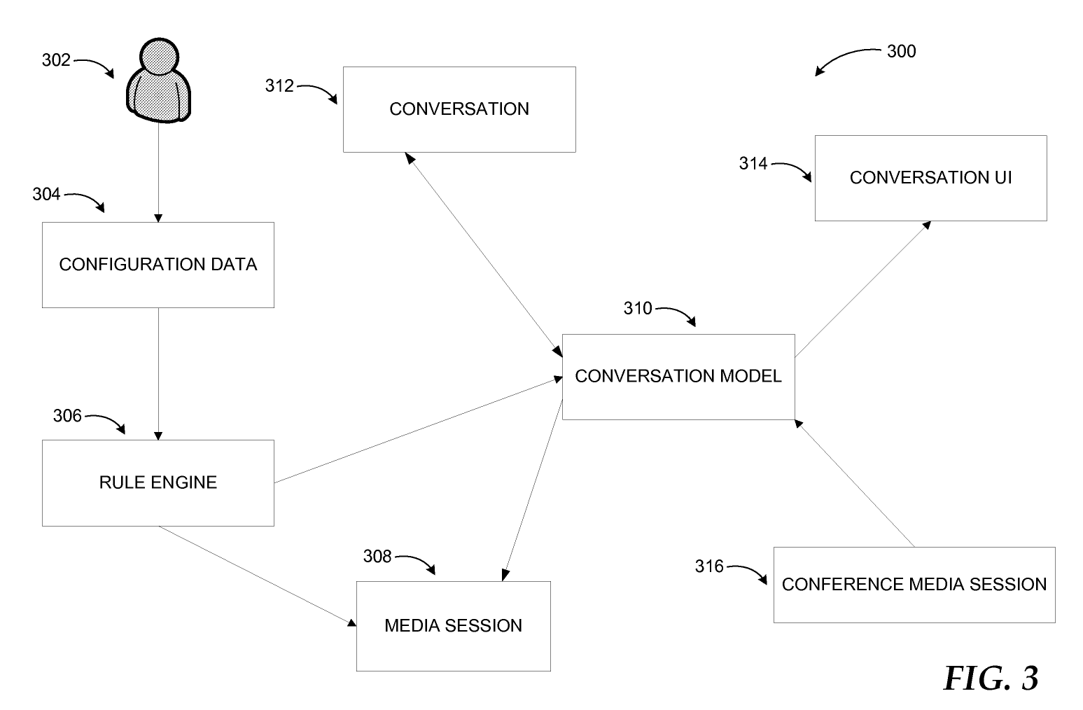

FIG. 3 includes block diagram 300 illustrating major components of a system according to embodiments for managing contextual information dependent modality selection. A client application according to embodiments may include a plurality of automata, which are configured to intelligently deduce an intuitive approach to determine whether or not an invite and which modalities of a multimodal invite to accept. Diagram 300 illustrates interactions between various components involved in achieving the configurable rule based framework for building a modality auto join experience. User 302 may specify the rules through configuration data 304, where conditions that affect the modality joining decision and data points associated with each condition may be specified. For example, a rule may have a condition that “DONOT AUTO-JOIN MODES IF USER IS AWAY FROM HER DESK” and the associated data point may be presence state being “Away”. User may also turn on other presence states like “off work”, “do not disturb”, and comparable ones.

The rules may be interpreted by a rule engine 306 and flushed to media session 308, which handles each mode in the conversation or the conversation itself for broad all mode related rules. The rules created from configuration data may be converted to properties that are in the language of each mode or conversation stored for use by media session 308 in decision making.

The conference notifications may be provided into the conversation model 310 from conference media session 316. At each significant event, each of the media sessions may be asked to process and determine if they need to perform any actions about the event. These decisions may be based on the computed properties that are cached in the media sessions (308). Conversation model 310 may be responsible for retrieving the rules created from configuration data across different modalities, interpret and store them. Eventually the conversation 312 may apply its overall rules trump any decisions made for individual modalities when necessary. The computed actions may be queued as a deferred or asynchronous action that may be invoked on the media sessions achieving the behavior outlined for various scenarios in the tables below.

Conversation model 310 may also provide prompts, alerts, and notifications to user 302 through conversation user interface 314 and receive user decisions overruling automatically generated/implemented rules. The configuration data may be extended to add more rules that are specific to clients using the framework as a platform. The mapping may be constructed by writing custom rules in the rule engine 306.

TABLE 1.1
Example scenarios and automated modality actions based on contextual information.

| | Pre-conversation | | | | In-conversation | | | |
|---|---|---|---|---|---|---|---|---|
| | | | App | | | | App | |
| Scenarios | Instant Message | Audio | Share | Content | Instant Message | Audio | Share | Content |

| | | | | |
|---|---|---|---|---|
| User receives an | Accept on Timeout | N/A | N/A | Prompt or Show Alert |
| incoming Instant | | | | |
| Message (IM), is | | | | |
| away from his | | | | |
| desk, does not | | | | |
| accept the IM, | | | | |
| and the invitation | | | | |
| times out | | | | |
| User receives an | Accept | None of the further | Accept | None of the further |
| invitation to a | automatically when | modalities may be alerted | automatically | modalities may be alerted |
| conference during | detected as IM, and | using audio alerts but, | when detected as | using audio alerts but, |
| a full screen | the window is kept | prompts to join the | IM, and the | prompts to join the |
| presentation | in the background. | modalities may remain | window is kept in | modalities may remain |
| | An automatic | for further user action | the background. | for further user action |
| | response is | | An automatic | |
| | generated to warn of | | response is | |
| | user's inattention to | | generated to warn | |
| | the message | | of user's | |
| | | | inattention to the | |
| | | | message | |

TABLE 1.2
Example scenarios and automated modality actions based on contextual information.

| | Pre-conversation | | | | In-conversation | | | |
|---|---|---|---|---|---|---|---|---|
| | | | App | | | | App | |
| Scenarios | Instant Message | Audio | Share | Content | Instant Message | Audio | Share | Content |

| | | | | |
|---|---|---|---|---|
| User is invited to | Accept | Prompt for all modalities | Accept | Prompt or show alert |
| a peer-to-peer | Automatically when | present in the invite and | automatically | |
| conversation for | detected | join when the user | when detected | |
| some modalities. | | interacts with the | | |
| The user is signed | | prompts | | |
| in at only one | | | | |
| endpoint | | | | |
| User is invited to | Accept | Prompt for all modalities | Accept | Prompt or show alert |
| a peer-to-peer | automatically when | present in the invite and | automatically | |
| conversation for | the user stops | join when the user clicks | when the user | |
| some modalities | activity at most | on the mode | stops activity at | |
| and user is signed | active endpoint | | most active | |
| in at more than | | | endpoint | |
| one endpoint | | | | |
| User receives an | Accept | No modality besides | Accept | No modality besides |
| invitation to a | automatically when | audio may be alerted | automatically | audio may be alerted |
| conference. Users | detected as IM, and | using audio alerts but, | when detected as | using audio alerts but, |
| engaged in audio | the window is kept | prompts to join the other | IM, and the | prompts to join the other |
| conversation | in the background. | modalities may remain | window is kept in | modalities may remain |
| | An automatic | until user action | the background. | until user action |
| | response is | | An automatic | |
| | generated to warn of | | response is | |
| | user's inattention to | | generated to warn | |
| | the message | | of user's | |
| | | | inattention to the | |
| | | | message | |

| | | Audio | Content | |
|---|---|---|---|---|
| User has joined | Join automatically | Prompt or | Join | Accept automatically (except for audio that |
| the conference | even if the user has | Show Alert | automat- | the user has joined via her mobile phone) |
| audio only via his | joined the | as the user | ically even | |
| mobile phone, | modalities from | has already | if the user | |
| arrives at his | another endpoint. | joined the | has joined | |
| desk, and joins | | conversation | the | |
| the conference via | | from | modalities | |
| the conference | | another | from | |
| link on the | | endpoint. | another | |
| computer | | | endpoint. | |

TABLE 1.3
Example scenarios and automated modality actions based on contextual information.

| | Pre-conversation | | | | In-conversation | | | |
|---|---|---|---|---|---|---|---|---|
| | | | App | | | | App | |
| Scenarios | Instant Message | Audio | Share | Content | Instant Message | Audio | Share | Content |

| | | | | |
|---|---|---|---|---|
| User receives an | Accept | Join all the rest of the | Accept | Prompt for all modalities |
| invitation to a | automatically when | modalities in the invite | automatically | present in the invite and |
| conference | detected as IM and | upon user action | when detected as | join upon user action |
| invoked by his | bring the window to | | IM and bring the | |
| manager | the foreground | | window to the | |
| | | | foreground | |
| User action on a | Accept | Automatically join the | Accept | Prompt or show alert for |
| link in an email | automatically when | modalities in a receive | automatically | audio always and never |
| invite to join a | detected | only or view only mode | when detected | start automatically |
| conference that | | | | |
| has a specific start | | | | |
| and end time | | | | |

| | | |
|---|---|---|
| User receives an | Start two | Automatic- |
| invite to a | way audio | ally join the |
| conference that | | modalities in |
| has a specific start | | a view only |
| and end time | | mode |

| | | | | |
|---|---|---|---|---|
| User action on a | Accept | Automatically join the | Accept | Prompt or show alert |
| link in the email | automatically when | modalities in a receive | automatically | always |
| invite to join an | detected | only or view only mode | when detected | |
| impromptu | | | | |
| conference which | | | | |
| has no start or end | | | | |
| times | | | | |

| | | |
|---|---|---|
| User receives an | Start two | Automatic- |
| invite to an | way audio | ally join the |
| impromptu | | modalities in |
| conference which | | a view only |
| has no start or end | | mode |
| times | | |

| | |
|---|---|
| Auto join to video | When user is participating in a peer-to-peer or a conference conversation and he has joined the |
| modality while | audio modality locally from the Voice Over IP endpoint then it is in the convenience of the |
| audio is already | user to automatically accept any video being added by the remote users. |
| active | However user participation is based off of whether there is enough bandwidth available and if |
| | so what size of video is acceptable for the user to see within the bandwidth constraints |
| Auto join to | When user is participating in a peer-to-peer or a conference conversation and he has joined |
| content or | either the application sharing or the content modalities then his conversation window is |
| application | already in a presentation modality and he is ready to accept the other modality. |
| sharing modality | However user participation is based off of whether there is enough bandwidth available and |
| when one or the | throttling of the amount of data shared with the user |
| other are already | |
| active | |

TABLE 1.4
Example scenarios and automated modality actions based on contextual information.

| | Pre-conversation | | | | In-conversation | | | |
|---|---|---|---|---|---|---|---|---|
| | | | App | | | | App | |
| Scenarios | Instant Message | Audio | Share | Content | Instant Message | Audio | Share | Content |

| | |
|---|---|
| Rejoining | Join modalities based on the state that the user was in before he was disconnected. |
| individual | Ex.: if he was muted before being disconnected, reconnect as muted |
| modalities after | Ex.: if he was a viewer of application sharing or content, return as a viewer. If he was |
| an un-intended | sharing a document then reconnect and automatically share the same document |
| disconnect | |
| Rejoining | If user chose to leave the modalities intentionally then the rejoin experience would be |
| individual | restrictive as he has stopped participating in the conversation. He has to join the meeting as |
| modalities after | a viewer or listener when he comes back |
| an intentional | User may join as a viewer of video or sharing, and user may not share out or send outgoing |
| disconnect | video (to prevent disruption of the meeting) |
| Rejoining the | Rejoining a conference after a complete disconnect means join back all modalities that |
| whole conference | were before and those that are newly created. |
| after an un- | Since the disconnect was un-intentional it is users expectation to go back to the state that |
| intentional | he was in present before being disconnected. |
| disconnect | User may be reconnected to the conference while joining all the modalities that he was in |
| | before as a presenter or sharer. He may join any new modalities that were added after he |
| | left in a restrictive fashion as a viewer to not disrupt any ongoing activity |
| Rejoining the | Rejoining a conference after a complete disconnect means join back all modalities that |
| whole conference | were present before and those that are newly created. |
| after an | Since the disconnect was intentional there is no user expectation to restore old state. |
| intentional | User may be reconnected to the conference joining all the modalities active in the |
| disconnect | conference in a restrictive fashion as a viewer to not disrupt any ongoing activity |

According to another example scenario, a user may be enabled to join a meeting by clicking on a link from their desktop computer when they have already connected to the same meeting through another endpoint (server only allows user to be connected on one modality from one endpoint at a given time). A system according to embodiments may transfer text messaging modality to the new end point (i.e. desktop). Since audio provides remote call control, using the conferencing protocol the audio controls may be kept up. If the user was viewing an application sharing display, then the viewing may be taken over from the new endpoint. If the user was sharing an application or data, then sharing may be stopped from the old endpoint.

In addition, third party applications may implement extensibility models by interacting with the client devices modality selection process. The third party applications may interface with the modality selection process via DLL or COM interfaces. The third party applications may provide key value pairs containing a new rule and information representing a state of the user (e.g. information from a social networking site). The third party applications may add/delete/modify rules in configurable list of automata rules, and may add/remove/disable rules in a pre-configured list of automata rules.

The above discussed scenarios, example systems, or applications are for illustration purposes. Embodiments are not restricted to the described examples. Other forms of automata rules may be used in implementing a contextual information dependent modality selection system in a similar manner using the principles described herein.

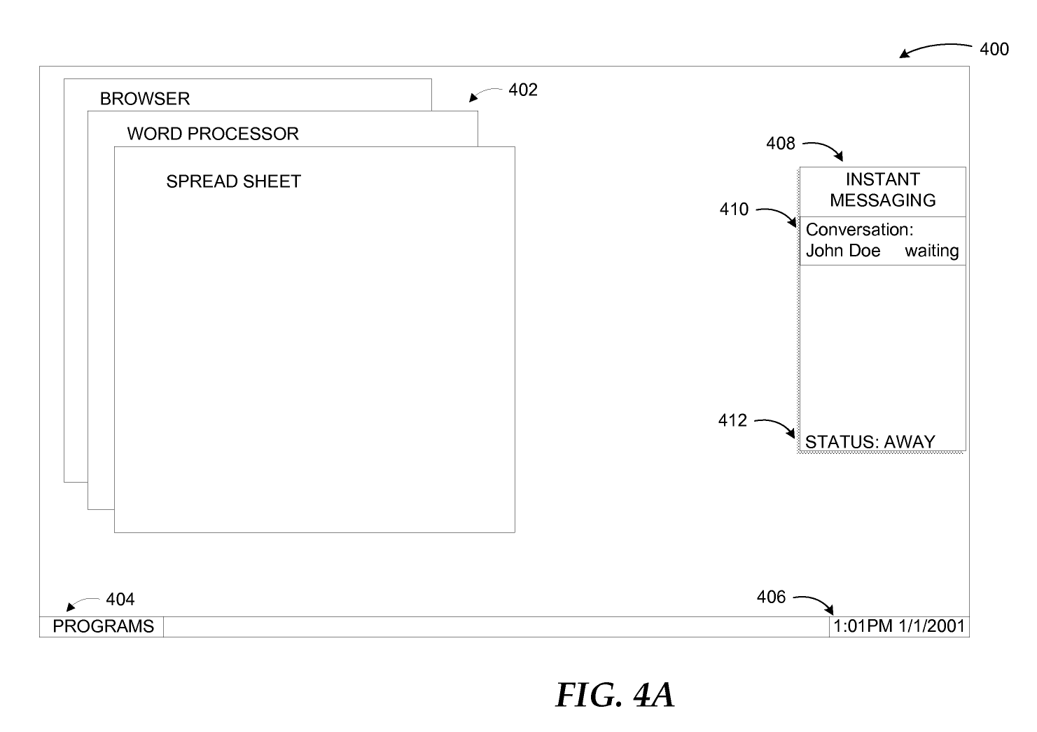

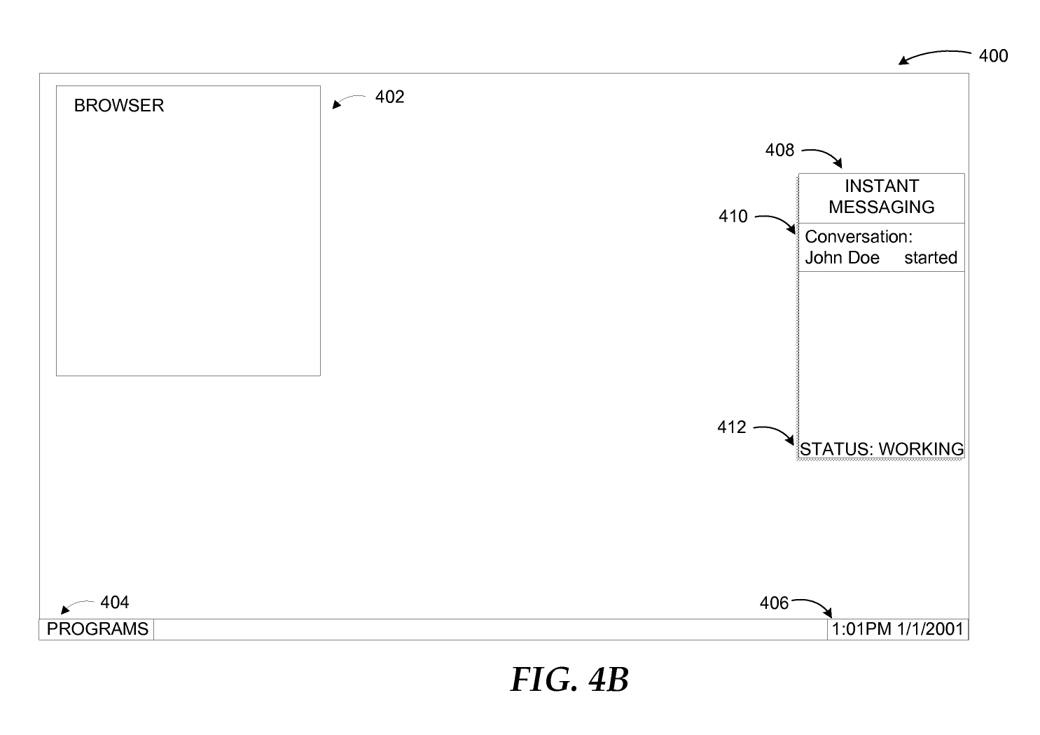

FIG. 4A illustrates example user interface 400 showing contextual information dependent modality selection according to some embodiments. As illustrated in FIG. 4A, user interface 400 (e.g. desktop) may display a number of applications 402 such as a browser, a word processor, and spread sheet. The desktop may also have conventional elements like a programs menu 404 and a date/time display 406. The user may also have a communication application user interface 408 active in instant messaging mode. The communication application user interface 408 may display various controls and information depending on active modalities. In the example scenario of FIG. 4A, only the instant messaging mode is active. Therefore, only controls for instant messaging are provided. The communication application user interface 408 displays an “AWAY” status 412 due to inactivity for a period.

In this environment, an incoming invite for an application sharing session from John Doe may not be accepted by the application based on a decision made from presence state of the user. The invite may still be displayed (410) in case the user is nearby and would like to accept. Alternatively, the communication application may put the invite on hold for a predefined period and then reject (or accept is user indication is received). In addition to the presence status, rules for rendering a decision on accepting or rejecting this new modality may be selected based on a priori context information such as three applications being active on the user's desktop environment (indicating the user is busy), client device characteristics such as screen dimensions (available viewing space for the requested application sharing session), resource availability (e.g. available computer memory or network bandwidth), and similar ones.

FIG. 4B illustrates the example user interface 400 of FIG. 4A under different circumstances. Unlike FIG. 4A, the desktop in user interface 400 includes only one active application (browser 402) other than the communication application user interface 408. Thus, there is enough viewing space available for an application sharing user interface on the desktop. Furthermore, as indicated by the presence status 412, the user is “working”. Hence, the communication application based on automatically selected rules may accept the application sharing invite (410) and notify the user saving the user the burden of having to accept the invite and manually select individual modality(ies).

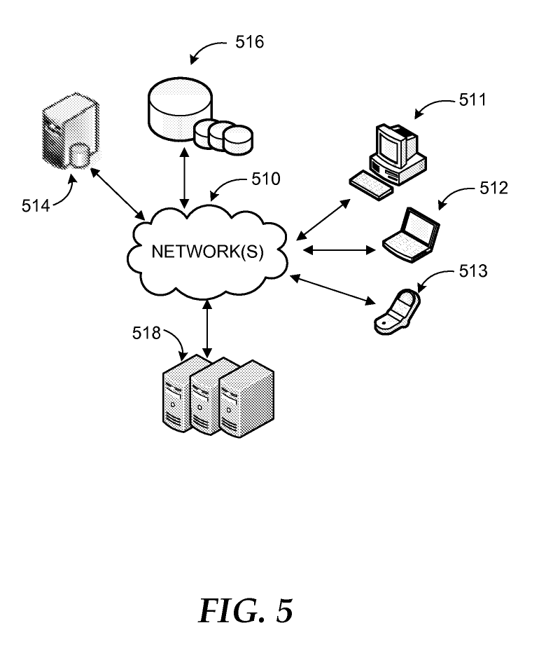

FIG. 5 is an example networked environment, where embodiments may be implemented. An enhanced communication system providing communication services including automatic modality selection based on contextual information may be implemented via software executed over one or more servers 518 such as a hosted service. The system may facilitate communications between client applications on individual computing devices such as a smart phone 513, a laptop computer 512, and desktop computer 511 (client devices') through network(s) 510.

As discussed above, modern communication technologies such as UC services enable subscribers to utilize a wide range of computing device and application capabilities in conjunction with communication services. This means, a subscriber may use one or more devices (e.g. a regular phone, a smart phone, a computer, a smart automobile console, etc.) to facilitate communications and multiple communication services by pre-configuring multiple automata rules to manage modality selection.

Client devices 511-513 are used to facilitate communications through a variety of modes between subscribers of the communication system. The client devices may manage contextual information dependent modality selection. One or more of the servers 518 may be used to facilitate communication as discussed above. Presence information may be stored in one or more data stores (e.g. data store 516), which may be managed by any one of the servers 518 or by database server 514. Client applications executed in client devices 511-513 may automatically accept or reject conversation invites for individual modalities based on contextual information retrieved from the client devices themselves, other information sources and as presence, directory, social networking servers, and the network itself.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a communication system with contextual information dependent modality selection management. Furthermore, the networked environments discussed in FIG. 5 are for illustration purposes only. Embodiments are not limited to the example applications, modules, or processes.

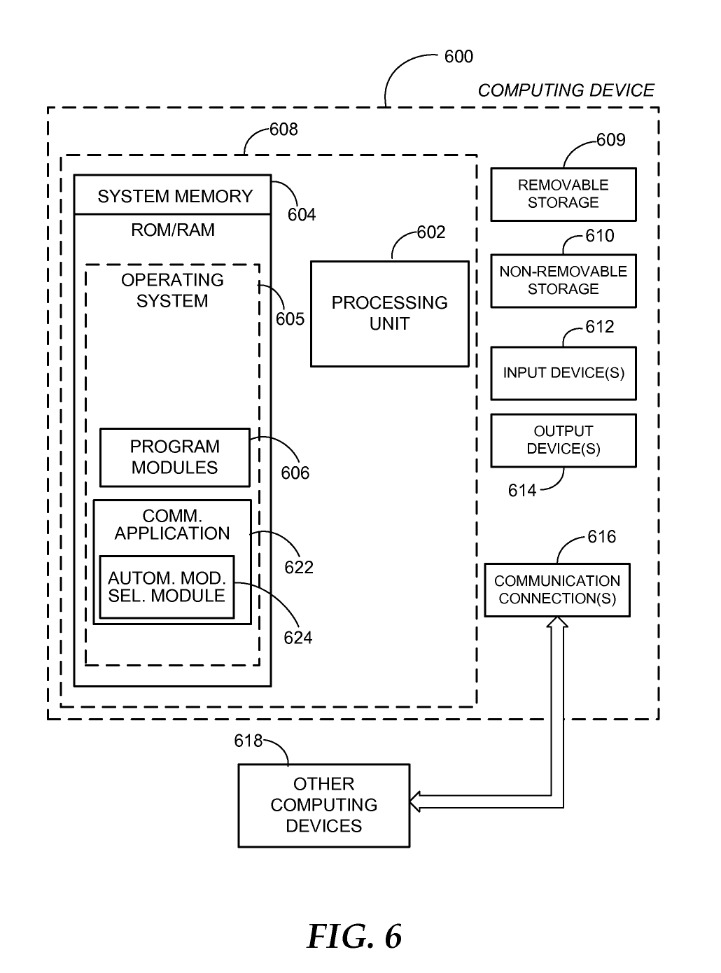

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a client device executing a communication application with contextual information dependent modality selection as part of an enhanced communication system and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, communication application 622, and automated modality selection module 624.

Communication application 622 may be part of a service that facilitates communication through various modalities between client applications, servers, and other devices. Automated modality selection module 624 may select modality(ies) to be accepted or rejected in invites for multimodal conversations based on contextual information according to user provided and automatically generated rules as discussed previously. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, other directory or policy servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

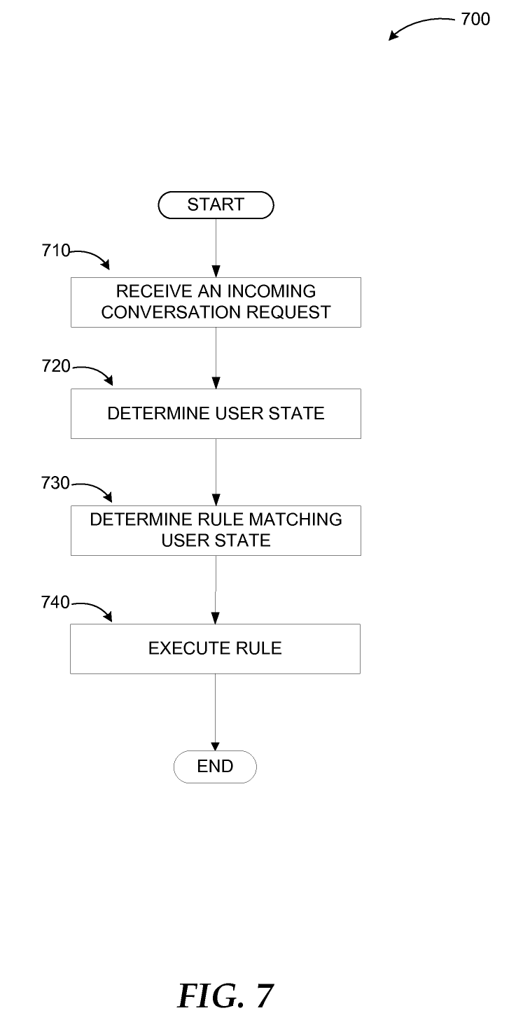

FIG. 7 illustrates a logic flow diagram of process 700 for managing contextual information dependent modality selection according to embodiments. Process 700 may be implemented by a communication application executed on a client device as part of an enhanced communication system.

Process 700 begins with operation 710, where a client device receives an incoming conversation request. The conversation request may be received by a plurality of end devices such as a smart phone, a desktop computer, and a notebook computer, each of which may have different characteristics such as memory, processing capacity, display size, display resolution, and similar ones, which may impact the quality of communication depending on a selected modality.

At operation 720, the user's state may be determined. The user's state may include a priori of information such as user's presence state, information about the user's device environment, user's network environment, type and other attributes of the incoming request, and similar data. Among the factors associated with the user's state may be the user's presence, which may include a current location of the user. For example, the user may be in an airplane, which may affect the modalities available or permitted for the user. According to another example, the call request may be from a supervisor, which may impact the acceptable/required modalities. A rule matching the user's current state may be determined automatically at operation 730. The rule may have properties matching the information determined from the user's state such as those listed above. The automata rules may also roam between multiple endpoints of the same user. For example, if the user specifies certain rules to allow video from people in his/her social network then the rule should be implemented regardless of which machine the user is currently using.

At operation 740, the matching rule may be executed resulting in automatic acceptance or rejection of one or more modalities of the incoming conversation request. The user may be notified in either case in order to provide an opportunity to manually override the automatic decision.

The operations included in process 700 are for illustration purposes. A contextual information dependent modality selection process according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing contextual information dependent call modality selection, the method comprising:
receiving a multimodal call request;
determining a state of a user based on known information associated with at least one from a set of: a client device characteristic, a network characteristic, a user characteristic, and a call characteristic;
determining a rule applicable to the state of the user; and
one of: accepting and rejecting at least one modality of the requested call based on the applicable rule.

2. The method of claim 1, wherein the client device characteristic includes at least one from a set of: available memory, available processing capacity, a video display capability, and an audio capability.

3. The method of claim 1, wherein the network characteristic includes at least one from a set of: available bandwidth and supported modalities.

4. The method of claim 1, wherein the call characteristic includes at least one from a set of: an importance level of a subject matter of the call, identities of participants in the call, and modalities of the call.

5. The method of claim 1, wherein the user characteristic includes at least one from a set of: user's presence, user's relationship with a requesting party for the call, user's currently active conversations through other client devices, user's currently active conversations through the client device, and user's currently active applications on the client device.

6. The method of claim 5, wherein the user characteristic further includes a type of, a number of, and an interaction of the user with the currently active applications on the client device.

7. The method of claim 5, wherein the client device and the other client devices include one from a set of: a cellular phone, a desktop phone, a desktop computer, a laptop computer, and a smart phone.

8. The method of claim 1, wherein the rule is defined by a user specified condition and at least one automatically determined data point.

9. The method of claim 8, wherein the condition specifies when a particular modality is to be accepted.

10. The method of claim 1, further comprising evaluating a plurality of applicable rules for the state of the user.

11. A computing device for facilitating multimodal conversations with contextual information dependent call modality selection, the computing device comprising:
a memory;
a processor coupled to the memory, the processor executing a communication application, wherein the communication application includes:
a rule engine configured to receive a plurality of conditions and corresponding data points to be interpreted as rules applicable to distinct states of the user;
a plurality of media sessions, each corresponding to a modality, configured to create rules for corresponding modalities and interpret the rules as properties;
a conversation model configured to create rules for the entire call and interpret the rules as properties such that at least one modality of the requested call is one of accepted and rejected based on one or more applicable rules.

12. The computing device of claim 11, wherein the states of the user are based on at least one from a set of: available memory, available processing capacity, a video display capability, and an audio capability of the client device; available bandwidth and supported modalities of a network; an importance level of a subject matter, identities of participants, and modalities of the call; and user's presence, currently active conversations through other client devices, currently active conversations through the client device, and currently active applications on the client device.

13. The computing device of claim 11, further comprising a configuration data store adapted to store sets of key value pairs for determining the conditions that affect an automatic acceptance behavior of the communication application.

14. The computing device of claim 11, the communication application is configured to enable a user to at least one of: accept a new modality for an established conversation through a new end point and move existing modalities to the new end point.

15. The computing device of claim 11, wherein the communication application is configured to enable a third party application to modify at least one rule by connecting to the rule engine through an interface.

16. The computing device of claim 11, wherein the rules created by the conversation model trump the rules created by the media sessions.

17. The computing device of claim 11, wherein an action decided based on evaluating the applicable rules is queued as one of a deferred action and an asynchronous action to be invoked subsequently on a media session.

18. A computer-readable storage medium with instructions stored thereon for managing contextual information dependent call modality selection, the instructions comprising:
receiving a multimodal call request;
determining a state of a user based on known information associated with at least one from a set of:
a client device characteristic comprising one or more of: available memory, available processing capacity, a video display capability, and an audio capability,
a network characteristic comprising one or more of: available bandwidth and supported modalities,
a user characteristic comprising one or more of: user's presence, user's currently active conversations through other client devices, user's currently active conversations through the client device, and user's currently active applications on the client device, and
a call characteristic comprising one or more of: an importance level of a subject matter of the call, identities of participants in the call, and modalities of the call;
determining a rule applicable to the state of the user; and
one of: accepting and rejecting at least one modality of the requested call based on the applicable rule.

19. The computer-readable storage medium of claim 18, wherein the instructions further comprise:
providing a notification to the user through a user interface such that the user is enabled to overrule automatic selection of at least one of the modalities of the requested call.

20. The computer-readable storage medium of claim 18, wherein the rules are specified as corresponding pairs of conditions and data points, and the user is enabled to define a portion of the conditions.
